(19) United States
(12) Patent Application Publication
(10) Pub. No.: US 2022/0099950 A1
(43) Pub. Date: Mar. 31, 2022

(54) Lens Device

(71) Applicants: Sintai Optical (Shenzhen) Co., Ltd., ShenZhen City (CN); Asia Optical Co., Inc., Taichung (TW)

(72) Inventor: Ming-Wei SHIH, Taichung (TW)

(21) Appl. No.: 17/460,423

(22) Filed: Aug. 30, 2021

(30) Foreign Application Priority Data
Sep. 30, 2020 (CN) 202011056162.9
Oct. 12, 2020 (CN) 202011081975.3

(51) Int. Cl. G02B 15/14; G02B 5/08; G02B 5/04

(52) U.S. Cl. CPC G02B 15/14; G02B 5/04; G02B 5/08

(57) ABSTRACT

A lens device includes at least one lens group, a first reflective element, and a second reflective element. The lens group enters the lens device from a first side to a second side along an optical path for imaging. The lens group is with refractive power. The first reflective element is disposed between the first side and the lens group, wherein the first reflective element includes a first reflective surface. The second reflective element is disposed between the first reflective surface and the second side, wherein the second reflective element includes a second reflective surface. The lens device satisfies the following condition: 22 mm<G1+LB<49 mm; wherein G1 is a maximum effective optical diameter of all the lenses in the lens group closest to the first side and LB is an interval from the first reflective surface to the second reflective surface along the optical path.

### BACKGROUND OF THE INVENTION

### Field of the Invention

The invention relates to a lens device.

### Description of the Related Art

Please refer to FIG. 1, FIG. 1 is a schematic diagram of a conventional periscope lens device. The lens device 10 includes a first reflective element P, a first lens group LG1, a second lens group LG2, a third lens group LG3, and an image sensor element (only the sensing surface SS is shown). The first reflective element P, the first lens group LG1, the second lens group LG2, the third lens group LG3, and the image sensor element are arranged in order from a first side to a second side along an optical path OA. In operation, the light from a third side incident on the first reflective element P from the first incident surface Sin along a vertical axis VA, and then reflected by the first reflective surface Sref to change the direction of propagation, and then sequentially passes through the first exit surface Sout, the first lens group LG1, the second lens group LG2, and the third lens group LG3, and finally forms an image on an image plane MA (sensing surface SS). Although the above-mentioned conventional periscope lens device is applied to a mobile phone can reduce the thickness of the mobile phone, but the total length of the lens (the interval between the first reflective surface Sref to the image plane IMA along the optical path OA) has not been shortened. With the increasing number of lenses used in mobile phone and the demand for optical zoom, the conventional periscope lens device still needs to further decrease the total lens length in order to meet the requirements of multiple lenses and optical zoom in today's mobile phone. Therefore, the lens device needs a new structure in order to meet the requirements of miniaturization, slimness, and optical zoom function at the same time.

### BRIEF SUMMARY OF THE INVENTION

The invention provides a lens device to solve the above problems. The lens device of the invention is provided with characteristics of a shortened total lens length, slimness, optical zoom function, and still has good optical performance.

The lens device in accordance with an exemplary embodiment of the invention includes at least one lens group, a first reflective element, and a second reflective element. The lens group enters the lens device from a first side to a second side along an optical path for imaging. The lens group is with refractive power. The first reflective element includes a first reflective surface and is disposed between the first side and the lens group. The second reflective element includes a second reflective surface and is disposed between the first reflective surface and the second side. The lens device satisfies: 22 mm<G1+LB<49 mm; wherein G1 is a maximum effective optical diameter of all the lenses in the lens group closest to the first side and LB is an interval from the first reflective surface to the second reflective surface along the optical path.

In another exemplary embodiment, the les device includes an image sensor element and the image sensor element includes a sensing surface disposed on an image plane and the sensing surface includes a long side and a short side.

In yet another exemplary embodiment, the lens device includes a plurality of lens groups, each of which includes at least one lens and the lens device zooms from a wide-angle end to a telephoto end by moving all the lens groups along the optical path at the same time, by moving part of the lens groups along the optical path at the same time, or by moving single one of the lens groups along the optical path.

In another exemplary embodiment, the lens group closest to the first side includes at least one lens, the first reflective element further includes a first incident surface and a first exit surface, the first incident surface and the first exit surface are perpendicular to each other, and the lens device satisfies: 1<C/G1<2; wherein C is a thickness of the first reflective element and the thickness is equal to a length of one side of the first exit surface along a direction perpendicular to the first incident surface.

In yet another exemplary embodiment, the lens device includes a plurality of lens groups, between which the lens group closest to the second side includes at least one lens, the first reflective element further includes a first incident surface and a first exit surface, the first incident surface and the first exit surface are perpendicular to each other, and the lens device satisfies: 1.1<C/G3<2.2; wherein C is a thickness of the first reflective element, the thickness is equal to a length of one side of the first exit surface along a direction perpendicular to the first incident surface, and G3 is a maximum effective optical diameter of all the lenses in the lens group closest to the second side.

In another exemplary embodiment, the lens device includes a plurality of lens groups, and an incident light sequentially passes through the first reflective element, the lens group closest to the first side, the lens group second closest to the second side, the second reflective element, and the lens group closest to the second side, to form an image on the image sensor element.

In yet another exemplary embodiment, the first reflective element further includes a first incident surface and a first exit surface, the first incident surface and the first exit surface are perpendicular to each other, and the lens device satisfies: 1.2<C/S<3.5; wherein C is a thickness of the first reflective element and the thickness is equal to a length of one side of the first exit surface along a direction perpendicular to the first incident surface, and S is a length of the short side of the sensing surface.

In another exemplary embodiment, the first reflective element is a prism or a mirror and the second reflective element is a prism or a mirror.

In yet another exemplary embodiment, the lens device includes a plurality of lens groups, each of which includes at least one lens, the first reflective element further includes a first incident surface and a first exit surface, the first incident surface and the first exit surface are perpendicular to each other, and the lens device satisfies at least one of the following conditions: 45 mm<LA<70 mm; 20 mm<LB<42 mm; 4 mm<C≤7.5 mm; 4 mm<G1<7 mm; 2.5 mm<G3<5.5 mm; where LA is an interval from the first reflective surface to an image plane along the optical path, G3 is a maximum effective optical diameter of all the lenses in the lens group closest to the second side, and C is a thickness of the first reflective element, wherein the thickness is equal to a length of one side of the first exit surface along a direction perpendicular to the first incident surface.

In another exemplary embodiment, the lens device includes a plurality of lens groups, each of which includes at least one lens, the first reflective element further includes a first incident surface and a first exit surface, the first incident surface and the first exit surface are perpendicular to each other, and the lens device satisfies at least one of the following conditions: 1<LA/LB<5; 25 mm<C+LB<50 mm; where LA is an interval from the first reflective surface to an image plane along the optical path and C is a thickness of the first reflective element, wherein the thickness is equal to a length of one side of the first exit surface along a direction perpendicular to the first incident surface.

The lens device in accordance with another exemplary embodiment of the invention includes at least one lens group and an annular body. The lens group is with refractive power. The lens group enters the lens device from a first side to a second side along an optical axis for imaging. The annular body is disposed between the first side and the second side. The lens group and the annular body are arranged along the optical axis. The annular body includes a first part surface and a second part surface, wherein the first part surface includes a first surface and a second surface, the second part surface includes a third surface, the first surface faces the first side, the third surface faces the second side, and the second surface is between the first surface and the third surface. The second surface surrounds the optical axis to form a hole. The lens device satisfies: 0.24 mm²≤AI≤0.91 mm²; wherein AI is an area of the second surface.

In another exemplary embodiment, the annular body is disposed between the first side and the lens group, between the lens group, or between the lens group and the second side, and the lens device satisfies at least one of the following conditions: 20 degrees/mm<θ/W<250 degrees/mm; 0.2 mm/mm²<W/AI<9 mm/mm²; wherein the second surface inclines to the optical axis and forms an angle with the third surface, θ is an angle value of the angle between the second surface and the third surface, W is a height of the third surface and the extension direction of the height is perpendicular to the optical axis, and AI is the area of the second surface.

In yet another exemplary embodiment, the lens device further includes a first reflective element and a second reflective element, wherein the first reflective element includes a first reflective surface and is disposed between the first side and the lens group, the second reflective element includes a second reflective surface and is disposed between the first reflective surface and the second side, and the lens group, the first reflective element, the second reflective element, and the annular body are arranged along the optical axis.

In another exemplary embodiment, the lens device further includes an image sensor element and the image sensor element includes a sensing surface disposed on an image plane and the sensing surface includes a long side and a short side, the first reflective element further includes a first incident surface and a first exit surface, the first incident surface and the first exit surface are perpendicular to each other, and the lens device satisfies at least one of the following conditions: 20 degrees≤θ≤60 degrees; 0.2 mm≤W≤1.55 mm; 22 mm<G1+LB<49 mm; 1<C/G1<2; 1.1<C/G3<2.2; 1.2<C/S<3.5; 45 mm<LA<70 mm; 20 mm<LB<42 mm; 4 mm<C≤7.5 mm; 4 mm<G1<7 mm; 2.5 mm<G3<5.5 mm; 1<LA/LB<5; 25 mm<C+LB<50 mm; 20 degrees/mm<θ/W<250 degrees/mm; 0.2 mm/mm²<W/AI<9 mm/mm²; wherein the second surface inclines to the optical axis and forms an angle with the third surface, θ is an angle value of the angle between the second surface and the third surface, W is a height of the third surface and the extension direction of the height is perpendicular to the optical axis, G1 is a maximum effective optical diameter of all the lenses in the lens group closest to the first side, LB is an interval from the first reflective surface to the second reflective surface along the optical path, C is a thickness of the first reflective element and the thickness is equal to a length of one side of the first exit surface along a direction perpendicular to the first incident surface, G3 is a maximum effective optical diameter of all the lenses in the lens group closest to the second side, S is a length of the short side of the sensing surface, LA is an interval from the first reflective surface to an image plane along the optical path, and AI is the area of the second surface.

The lens device in accordance with yet another exemplary embodiment of the invention includes at least one lens group and an annular body. The lens group is with refractive power. The lens group enters the lens device from a first side to a second side along an optical axis for imaging. The annular body is disposed between the first side and the second side. The lens group and the annular body are arranged along the optical axis. The annular body includes a first part surface and a second part surface, wherein the first part surface includes a first surface and a second surface, the second part surface includes a third surface, the first surface faces the first side, the third surface faces the second side, and the second surface is between the first surface and the third surface. The second surface surrounds the optical axis to form a hole. The lens device satisfies: 5<H/T<48; wherein H is a height of the second surface, the extension direction of the height is perpendicular to the optical axis, T is a thickness between the second surface and the third surface, and the extension direction of the thickness is parallel to the optical axis.

In another exemplary embodiment, the annular body is disposed between the first side and the lens group, between the lens group, or between the lens group and the second side, the second surface faces the first side, the first part surface further includes a fourth surface, a fifth surface, and a sixth surface, the fourth surface connects the first surface and the third surface, the second surface connects the fifth surface and the sixth surface, the fifth surface intersects the second surface, the sixth surface connects the second surface and the third surface, and the lens device satisfies at least one of the following conditions: 9 mm<B/H<11 mm; 3<B/CA<50; 0.1×L≤T≤0.4×L; wherein B is an area of the second surface, H is the height of the second surface, the extension direction of the height is perpendicular to the optical axis, CA is an area of the sixth surface, L is a thickness of the fourth surface, the extension direction of the thickness is parallel to the optical axis, and T is the thickness between the second surface and the third surface and the extension direction of the thickness is parallel to the optical axis.

In yet another exemplary embodiment, the lens device satisfies the following condition: 0.05 mm≤H≤0.15 mm; wherein H is the height of the second surface.

In another exemplary embodiment, the lens device satisfies the following condition: 0.02 mm≤L≤2 mm; wherein L is the thickness of the fourth surface.

In yet another exemplary embodiment, the lens device further includes an image sensor element and the image sensor element includes a sensing surface disposed on an image plane and the sensing surface includes a long side and a short side, the first reflective element further includes a first incident surface and a first exit surface, the first incident surface and the first exit surface are perpendicular to each other, the hole is a non-circular hole and an interval between the second surface and the third surface along the optical axis is smaller than an interval between the first surface and the third surface along the optical axis, the annular body is a non-circular annular body and made of metal or polyethylene terephthalate (PET), the first surface and the third surface are connected by at least two turning points, and the lens device satisfies at least one of the following conditions: 0.2 mm≤W≤1.55 mm; 9 mm<B/H<11 mm; 3<B/CA<50; 0.1×L≤T≤0.4×L; 0.05 mm≤H≤0.15 mm; 0.02 mm≤L≤2 mm; 22 mm<G1+LB<49 mm; 1<C/G1<2; 1.1<C/G3<2.2; 1.2<C/S<3.5; 45 mm<LA<70 mm; 20 mm<LB<42 mm; 4 mm<C≤7.5 mm; 4 mm<G1<7 mm; 2.5 mm<G3<5.5 mm; 1<LA/LB<5; 25 mm<C+LB<50 mm; wherein W is a height of the third surface and the extension direction of the height is perpendicular to the optical axis, B is an area of the second surface, H is the height of the second surface and the extension direction of the height is perpendicular to the optical axis, CA is an area of the sixth surface, L is a thickness of the fourth surface and the extension direction of the thickness is parallel to the optical axis, T is the thickness between the second surface and the third surface and the extension direction of the thickness is parallel to the optical axis, G1 is a maximum effective optical diameter of all the lenses in the lens group closest to the first side, LB is an interval from the first reflective surface to the second reflective surface along the optical path, C is a thickness of the first reflective element and the thickness is equal to a length of one side of the first exit surface along a direction perpendicular to the first incident surface, G3 is a maximum effective optical diameter of all the lenses in the lens group closest to the second side, S is a length of the short side of the sensing surface, and LA is an interval from the first reflective surface to an image plane along the optical path.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a conventional periscope lens device;

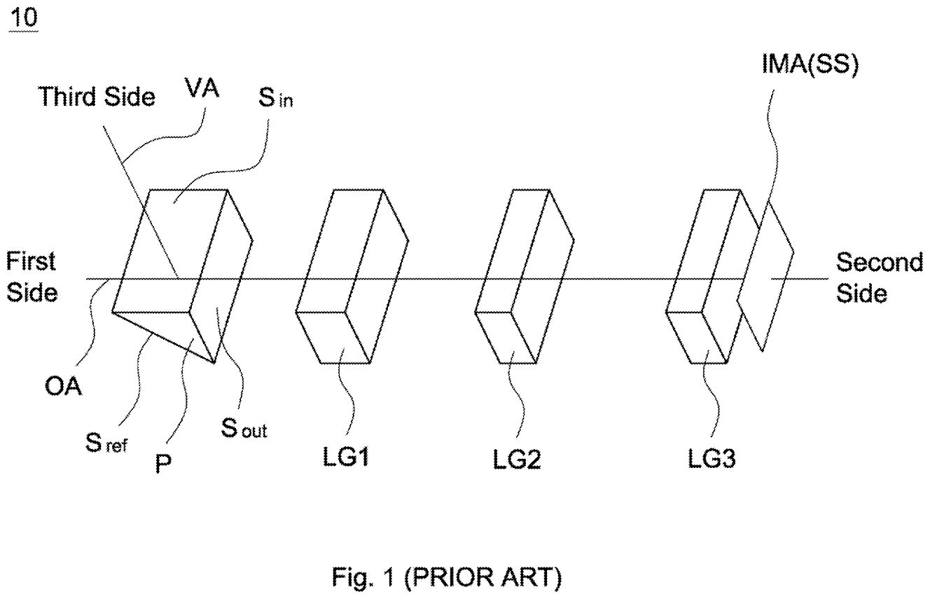

FIG. 2 is a lens layout diagram of a lens device at a wide-angle end in accordance with a first embodiment of the invention;

FIG. 3 is a schematic diagram of the lens device during zooming in accordance with the first embodiment of the invention;

FIG. 4 is a schematic diagram of a first reflective element in accordance with the first embodiment of the invention;

FIG. 5 is a schematic diagram of a sensing surface in accordance with the first embodiment of the invention;

FIG. 6A is a schematic diagram of a first part surface view of an annular body of a conventional lens device;

FIG. 6B is a schematic diagram of a VII-VII sectional view of the annular body in according to FIG. 6A;

FIG. 6C is a schematic diagram of optical paths of incident light on the annular body of FIG. 6A;

FIG. 7A is a schematic diagram of a first part surface view of an annular body of a lens device in accordance with a second embodiment of the invention;

FIG. 7B is a schematic diagram of a VII-VII sectional view of the annular body in according to FIG. 7A;

FIG. 7C is a schematic diagram of optical paths of incident light on the annular body of FIG. 7A;

FIG. 8A is a schematic diagram of a first part surface view of an annular body of a lens device in accordance with a third embodiment of the invention;

FIG. 8B is a schematic diagram of a VII-VII sectional view of the annular body in according to FIG. 8A; and

FIG. 8C is a schematic diagram of optical paths of incident light on the annular body of FIG. 8A.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens device including at least one lens group, a first reflective element, and a second reflective element. The lens group is with refractive power. The lens group enters the lens device from a first side to a second side along an optical path for imaging. The first reflective element includes a first reflective surface and is disposed between the first side and the lens group. The second reflective element includes a second reflective surface and is disposed between the first reflective surface and the second side. The lens device satisfies: 22 mm<G1+LB<49 mm; wherein G1 is a maximum effective optical diameter of all the lenses in the lens group closest to the first side and LB is an interval from the first reflective surface to the second reflective surface along the optical path.

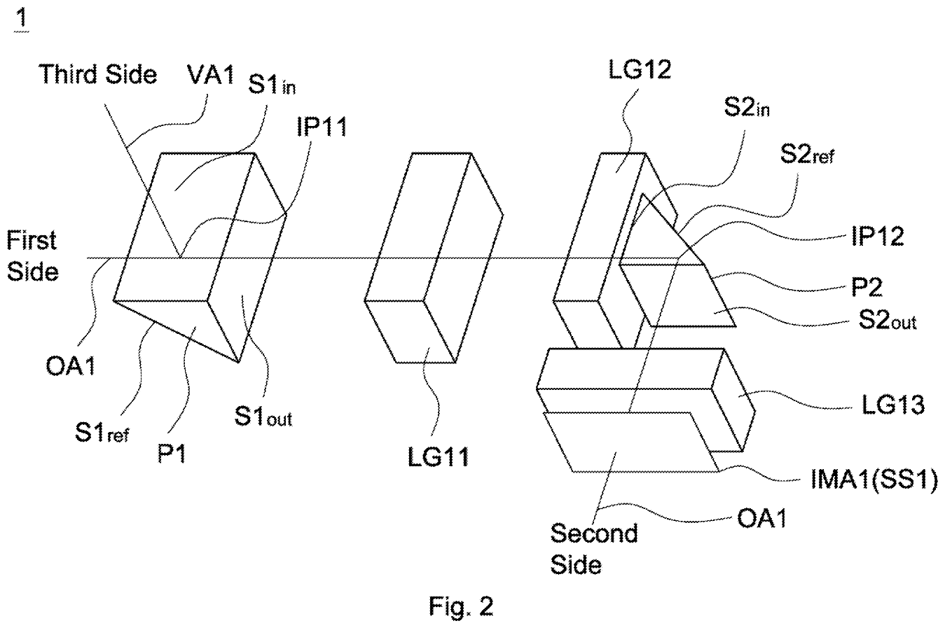

Referring to FIG. 2, FIG. 2 is a lens layout diagram of a lens device at a wide-angle end in accordance with a first embodiment of the invention. The lens device 1 includes a plurality of lens groups, a first reflective element P1, a second reflective element P2, and an image sensor element (only the sensing surface SS1 is shown).

The plurality of lens groups includes a lens group LG11 closest to the first side, a lens group LG12 second close to the second side, and a lens group LG13 closet to the second side. The lens group LG11 closest to the first side, the lens group LG12 second close to the second side, and the lens group LG13 closest to the second side include at least one lens (not shown), respectively. The lens group LG11 closest to the first side, the lens group LG12 second close to the second side, and the lens group LG13 closest to the second side are arranged in order from a first side to a second side along an optical path OA1. The lens group LG11 closest to the first side is the closest to the first side. The lens group LG12 second close to the second side is the second close to the second side. The lens group LG13 closest to the second side is the closest to the second side. The optical path OA1 is the path of the incident light on the optical axis and can also be regarded as the optical axis.

The first reflective element P1 is a prism including a first incident surface S1in, a first reflective surface S1ref, and a first exit surface S1out. The first incident surface S1in faces a third side along the vertical axis VA1. The first reflective surface S1ref faces the second side along the optical path OA1. The first exit surface S1out faces the second side along the optical path OA1. The first incident surface S1in and the first exit surface S1out are perpendicular to each other. The first reflective element P1 can also be a mirror, when it is a mirror, it can only include a reflective surface. The first reflective element P1 is disposed between the first side and the lens group LG11 closest to the first side.

The second reflective element P2 is a prism including a second incident surface S2in, a second reflective surface S2ref, and a second exit surface S2out. The second incident surface S2in faces the first side along the optical path OA1. The second reflective surface S2ref faces the second side along the optical path OA1. The second exit surface S2out faces the second side along the optical path OA1. The second incident surface S2in and the second exit surface S2out are perpendicular to each other. The second reflective element P2 can also be a mirror, when it is a mirror, it can only include a reflective surface. The second reflective element P2 is disposed between the lens group LG12 second close to the second side and the lens group LG13 closest to the second side.

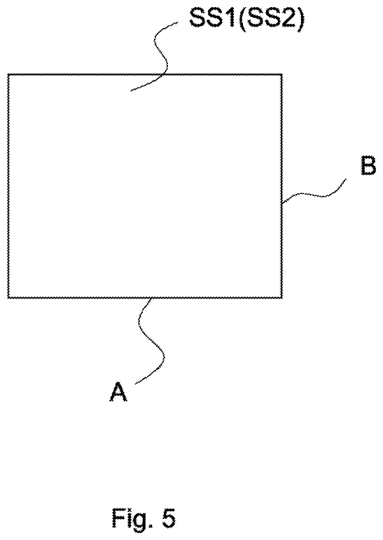

The image sensor element includes a sensing surface SS1, and the sensing surface SS1 coincides with an image plane IMA1. The sensing surface SS1 is a rectangular and includes a long side A and a short side B (as shown in FIG. 5). The length L of the long side to the length S of the short side is 4 to 3 (as shown in FIG. 5, L:S=4.184 mm:3.138 mm=4:3). The above-mentioned image sensor element can also be replaced to the length L of the long side to the length S of the short side is 16 to 9 (for example, L:S=4.558 mm:2.564 mm=16:9) which should also belong to the scope of the present invention.

The optical path OA1 intersects the first reflective surface S1in at a point IP11 and the second reflective surface S2ref at a point IP12, and then changes direction to the second side. A vertical axis VA1 passes through the first incident surface S1in perpendicularly and intersects the optical path OA1 and the first reflective surface S1ref at the point IP11. The line from the vertical axis VA1 is turned 90 degrees through the point IP11 to the point IP12 and then turned 90 degrees to perpendicularly pass through the image plane IMA1 is the optical axis of the lens device 1. In operation, an incident light from the third side enters the first reflective element P1 from the first incident surface S1in is reflected by the first reflective surface S1ref to change the propagation direction, and then sequentially passes through the first exit surface S1out, the lens group LG11 closest to the first side, the lens group LG12 second close to the second side, the second incident surface S2in, and then reflected by the second reflective surface S2ref to change the propagation direction, and then sequentially passes through the second exit surface S2out and the lens group LG13 closest to the second side, and finally forms an image on the image plane IMA1 (sensing surface SS1). The image plane IMA1 (sensing surface SS1) and the first incident surface S1in are perpendicular to each other. In other words, the incident light sequentially passes through the first reflective element P1, the lens group LG11 closest to the first side, the lens group LG12 second close to the second side, the second reflective element P2, and the lens group LG13 closest to the second side, and then images on the image sensor element.

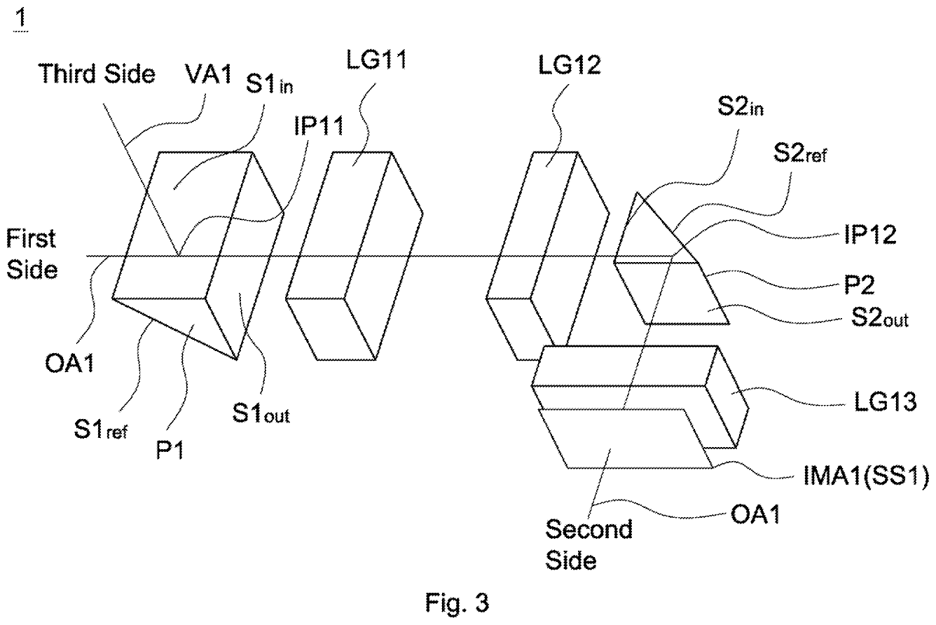

The lens group LG1 closest to the first side, the lens group LG12 second close to the second side, and the lens group LG13 closest to the second side can all move along the optical path OA1 at the same time, so that the lens device can zoom from a wide-angle end to a telephoto end (not shown), or the lens group LG11 closest to the first side, the lens group L012 second close to the second side, and the lens group LG13 closest to the second side can partially move along the optical path OA1 at the same time, so that the lens device can zoom from a wide-angle end to a telephoto end (as shown in FIG. 3), or the lens group LG11 closest to the first side, the lens group LG12 second close to the second side, and the lens group LG13 closest to the second side can move by a single lens group along the optical path OA1, so that the lens device can zoom from a wide-angle end to a telephoto end (not shown).

In addition, the lens device 1 satisfies at least one of the following conditions:

1<LA/LB<5; (1)

1<C/G1<2; (2)

1.1<C/G3<2.2; (3)

1.2<C/S<3.5; (4)

25 mm<C+LB<50 mm; (5)

45 mm<LA<70 mm; (6)

20 mm<LB<42 mm; (7)

4 mm<C≤7.5 mm; (8)

4 mm<G1<7 mm; (9)

25 mm<G3<5.5 mm; (10)

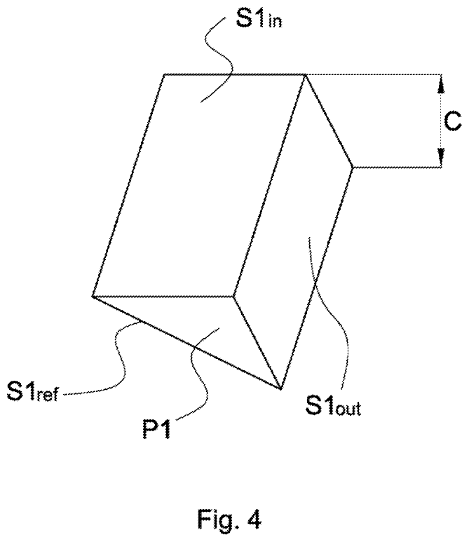

22 mm<G1+LB<49 mm; (11)

wherein LA is an interval from the first reflective surface S1ref to the image plane SS1 along the optical path OA1, LB is an interval from the first reflective surface S1ref to the second reflective surface S2ref along the optical path OA1, C is a thickness of the first reflective element P1 wherein the thickness is equal to a length of one side of the first exit surface S1out along the direction perpendicular to the first incident surface S1in (as shown in FIG. 4 mark C), 01 is a maximum effective optical diameter of all the lenses of the lens group LG11 closest to the first side, G3 is a maximum optical diameter of all the lenses of the lens group LG13 closest to the second side, and S is a length of the short side A of the sensing surface SS1.

By using the above-mentioned lens groups, the first reflective element P1, the second reflective element P2, the image sensor element, and satisfying at least any one of the conditions (1) to (11), the lens device 1 can effectively shorten the total lens length, effectively increased the available space inside the mobile phone, and can achieve optical zoom with higher magnification by a longer effective focal length.

When the condition (1): 1<LA/LB<5 is satisfied, it can have a longer effective focal length and achieve the effect of shortening the total length of the lens device at the same time, and add more space to mobile phone with multiple lenses permutation and combination.

When the condition (2): 1<C/G1<2 is satisfied, it is beneficial to the assembly of the lens device and can improve the manufacturing yield rate.

When the condition (3): 1.1<C/G3<2.2 is satisfied, the effective optical diameter and refractive power change of the lens group closest to the second side can be effectively controlled which is helpful for the autofocus function and the miniaturization of the lens device.

When the condition (4): 1.2<C/S<3.5 is satisfied, the ratio of the thickness of the first reflective element to the length of the short side of the sensing surface can be appropriately controlled which can help reduce the thickness of the lens device and achieve the purpose of slimness.

When the condition (5): 25 mm<C+LB<50 mm is satisfied, it helps to miniaturize the lens device and achieves better optical specifications, and also maintains the stability of the manufacturing quality and size for the lens device.

When conditions (6)-(10): 45 mm<LA<70 mm, 20 mm<LB<42 mm, 4 mm<C≤7.5 mm, 4 mm<G1<7 mm, 2.5 mm<G3<5.5 mm are satisfied, the total length of the optical imaging system of the lens device can be controlled within an appropriate range to meet various applications, and it is helpful to adjust the configuration of the lens group. Furthermore, the compression for the size and volume of the lens device have been improved, the response efficiency of the image sensor element can be improved, and also greatly improves the ease of assembly of the lens device. A balance can be achieved between compressing the total length of the optical system and increasing the sensing surface of the image sensor element.

When the condition (11): 22 mm<G1+LB<49 mm is satisfied, it is beneficial to adjust the lens distribution of the optical imaging system at the object side, thereby helping to compress the total length of the lens device and avoiding the refractive power of the lens group closest to the first side is too strong to reduce the sensitivity of the optical imaging system and aberration.

Tables 1, 2, and 3 show the parameters and condition values for conditions (1)-(11) in accordance with the first embodiment of the invention. It can be seen from Tables 1, 2, and 3 that the lens device 1 of the first embodiment satisfies the conditions (1)-(11).

TABLE 1

| LA(mm) | LB(mm) | LA/LB |
|---|---|---|
| 69.77 | 40.26 | 1.73 |
| 64.96 | 40.26 | 1.61 |
| 59.82 | 40.26 | 1.49 |
| 52.01 | 40.26 | 1.29 |
| 49.43 | 40.26 | 1.23 |
| 59.82 | 21.7 | 2.76 |
| 59.82 | 37.53 | 1.59 |
| 59.82 | 38.71 | 1.55 |
| 59.82 | 39.36 | 1.52 |
| 59.82 | 40.26 | 1.49 |

TABLE 2

| C(mm) | G1(mm) | G3(mm) | S(SS1) | S(SS3) | C/G1 | C/G3 | C/S(SS1) | C/S(SS2) |
|---|---|---|---|---|---|---|---|---|
| 7.5 | 6.1 | 4.9 | 3.138 | 2.564 | 1.23 | 1.53 | 2.39 | 2.93 |
| 7 | 5.6 | 4.4 | 3.138 | 2.564 | 1.25 | 1.59 | 2.23 | 2.73 |
| 6.5 | 5.1 | 3.9 | 3.138 | 2.564 | 1.27 | 1.67 | 2.07 | 2.54 |
| 6 | 4.6 | 3.4 | 3.138 | 2.564 | 1.30 | 1.76 | 1.91 | 2.34 |
| 5.5 | 4.1 | 2.9 | 3.138 | 2.564 | 1.34 | 1.90 | 1.75 | 2.15 |

TABLE 3

| LB(mm) | | 21.7 | | 37.53 | | 38.71 | | 39.36 | | 40.26 | |
|---|---|---|---|---|---|---|---|---|---|---|---|
| C | C + | 5.5 | 27.2 | 5.5 | 43.03 | 5.5 | 44.21 | 5.5 | 44.86 | 5.5 | 45.76 |
| (mm) | LB | 6 | 27.7 | 6 | 43.53 | 6 | 44.71 | 6 | 45.36 | 6 | 46.26 |
| | (mm) | 6.5 | 28.2 | 6.5 | 44.03 | 6.5 | 45.21 | 6.5 | 45.86 | 6.5 | 46.76 |
| | | 7 | 28.7 | 7 | 44.53 | 7 | 45.71 | 7 | 46.36 | 7 | 47.26 |
| | | 7.5 | 29.2 | 7.5 | 45.03 | 7.5 | 46.21 | 7.5 | 46.86 | 7.5 | 47.76 |
| G1 | G1 + | 4.1 | 25.8 | 4.1 | 41.63 | 4.1 | 42.81 | 4.1 | 43.46 | 4.1 | 44.36 |
| (mm) | LB | 4.6 | 26.3 | 4.6 | 42.13 | 4.6 | 43.31 | 4.6 | 43.96 | 4.6 | 44.86 |
| | (mm) | 5.1 | 26.8 | 5.1 | 42.63 | 5.1 | 43.81 | 5.1 | 44.46 | 5.1 | 45.36 |
| | | 5.6 | 27.3 | 5.6 | 43.13 | 5.6 | 44.31 | 5.6 | 44.96 | 5.6 | 45.86 |
| | | 6.1 | 27.8 | 6.1 | 43.63 | 6.1 | 44.81 | 6.1 | 45.46 | 6.1 | 46.36 |

In the above-mentioned embodiment, the lens device includes a lens group closest to the first side, a lens group second close to the second side, and a lens group closest to the second side, a total of three lens groups. However, it can be understood that the lens device can also include only one lens group, two lens groups, or at least four lens groups should also fall within the scope of the present invention.

The lens device 1 of the first embodiment can also add an annular body disposed between the first side and the second side. The function of the annular body is the same as a stop which related to F-Number, can effectively shield stray light, effectively reduce ghost image, and improve image quality. The structure and function of the annular body will be explained further below.

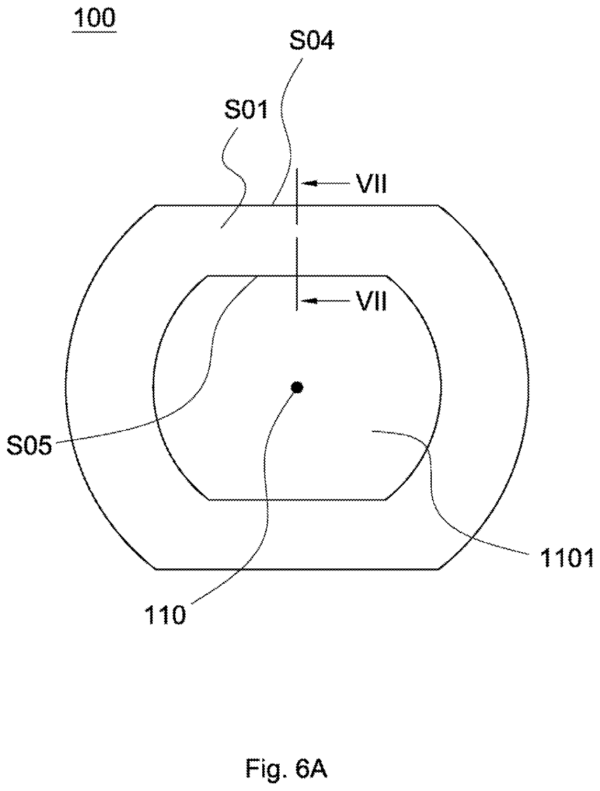

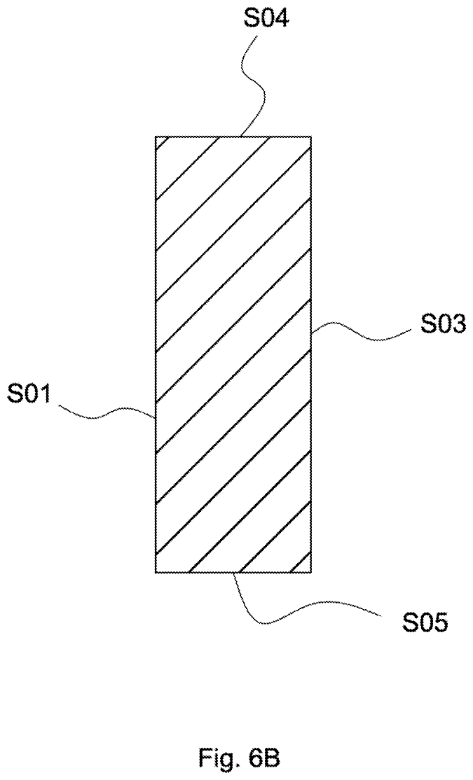

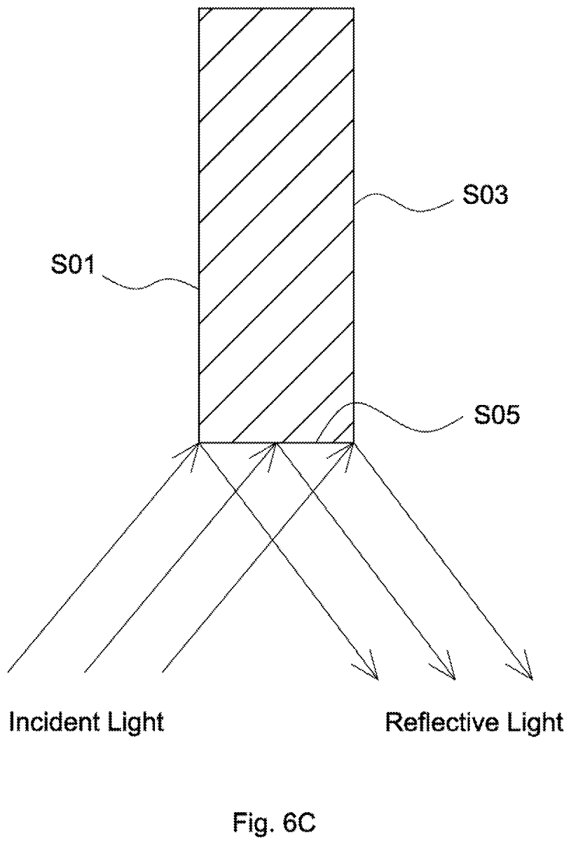

The main function of the annular body is the stop function. The annular body can block light from passing through and the hole is formed around the annular body allows light to pass through. Please refer to FIG. 6A and FIG. 6B at the same time, FIG. 6A is a schematic diagram of a first part surface view of an annular body of a conventional lens device and FIG. 6B is a schematic diagram of a VII-VII sectional view of the annular body in according to FIG. 6A. The annular body 100 includes a first surface S01, a third surface S03, a fourth surface S04, and a fifth surface SOS. The first surface S01 connects the fourth surface S04 and the fifth surface S05, respectively. The third surface S03 connects the fourth surface S04 and the fifth surface S05, respectively. The fifth surface SOS is perpendicular to the first surface S01 and the third surface S03, respectively. The shape of the annular body 100 is a racetrack shape (non-circular), i.e. a shape formed by cutting out upper or lower portions of a circle, the fifth surface S05 forms a hole 1101 around an optical axis 110, the hole 1101 is a racetrack shape (non-circular), and the light from the first side (not shown) can pass through the hole 1101. The dimension of the hole 1101 affects the amount of light passing through the lens device (not shown). Please refer to FIG. 6C, FIG. 6C is a schematic diagram of optical paths of incident light on the annular body of FIG. 6A. The fifth surface 305 in FIG. 6C is perpendicular to the first surface S01 and the third surface 303, respectively. When the incident light from the first side (not shown) enters the annular body 100, most of the incident light is blocked by the first surface 301 and cannot pass through the hole 1101, but part of the incident light is directly reflected after incident on the fifth surface S05. The reflected light passes through the hole 1101 and finally be imaged on the image plane to form a so-called ghost image which reduces the image quality.

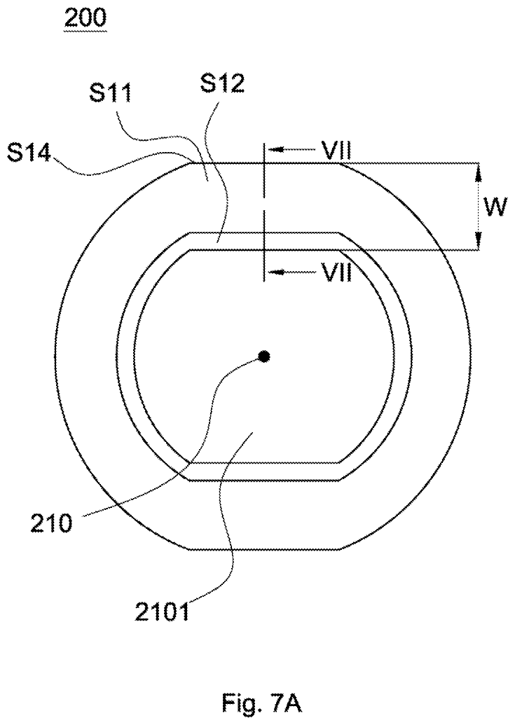

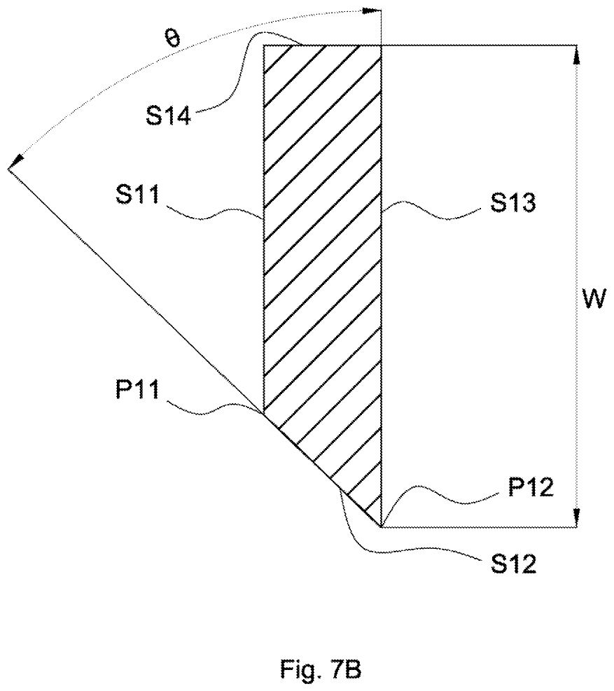

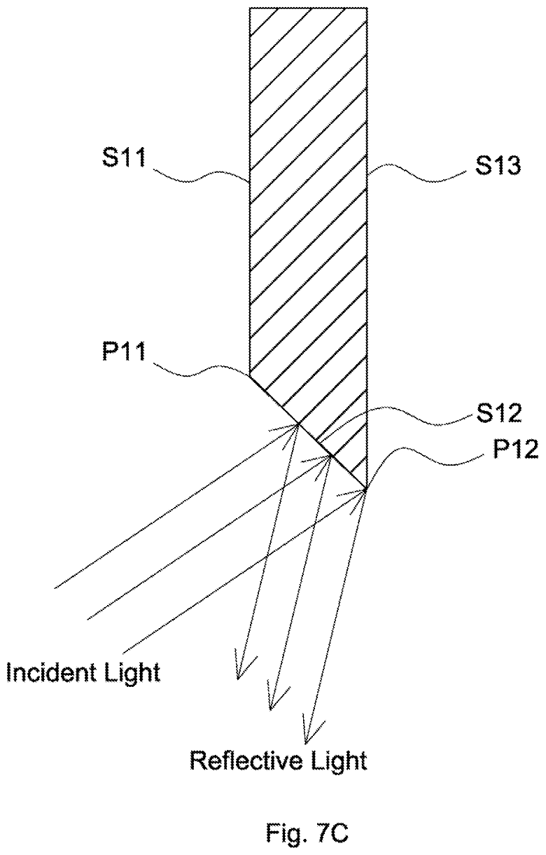

Please refer to FIG. 7A and FIG. 7B at the same time, FIG. 7A is a schematic diagram of a first part surface view of an annular body of a lens device in accordance with a second embodiment of the invention and FIG. 7B is a schematic diagram of a VI-VII sectional view of the annular body in according to FIG. 7A. As shown in FIGS. 2A and 2B, the lens device 2 (not shown) includes a plurality of lenses (not shown) and an annular body 200. The plurality of lenses (not shown) and the annular body 200 are arranged along an optical axis 210. The annular body 200 is disposed between a first side (not shown) and a second side (not shown). In other words, the annular body 200 may be disposed between the first side (not shown) and the plurality of lenses (not shown), between the plurality of lenses (not shown), or between the plurality of lenses (not shown) and the second side (not shown). The annular body 200 may be made of polyethylene terephthalate and includes a first part surface and a second part surface. The first part surface includes a first surface S11, a second surface S12, and a fourth surface S14. The second part surface includes a third surface S13. The second surface S12 connects the first surface S11 and the third surface S13, respectively. The fourth surface S14 connects the first surface S11 and the third surface S13, respectively. The second surface S12 inclines to the optical axis 210 and forms an angle with the third surface S13 and the angle value is equal to θ. The first surface S11 faces the first side and the third surface S13 faces the second side. The shape of the annular body 200 can be non-circular, such as racetrack shape, polygon, polygon symmetrical to optical axis, bottle shape, oak barrel shape or upper half of red wine bottle. The second surface S12 forms a hole 2101 around the optical axis 210. The hole 2101 is non-circular, such as racetrack shape, polygon, polygon symmetrical to optical axis, bottle shape, oak barrel shape, upper half of red wine bottle, a shape formed by cutting out upper or lower portions of a circle, wave shape, zigzag shape, concave-convex shape, petal shape, and heart shape. The hole 2101 allows the light from the first side (not shown) to pass through, and its dimension affects the amount of light passing through the lens device (not shown), so the main function of the annular body 200 is the stop function.

Please refer to FIG. 7C, FIG. 7C is a schematic diagram of optical paths of incident light on the annular body of FIG. 7A. When the incident light from the first side (not shown) enters the annular body 200, most of the incident light is blocked by the first surface S11 and cannot pass through the hole 2101, but part of the incident light is directly reflected after incident on the second surface S12 to change the light path. Because the angle 9 between the second surface S12 and the third surface S13 is not 90 degrees, the reflected light cannot pass through the hole 2101. Therefore, the reflected light cannot form stray light and thus avoid ghost image, so that the image quality can be improved. Problems such as ghost image and stray light have been improved.

In addition, the annular body 200 satisfies at least one of the following conditions:

20 degrees/mm<θ/W<250 degrees/mm; (12)

0.2 mm/mm²<W/AI<9 mm/mm²; (13)

20 degrees≤θ≤60 degrees; (14)

0.2 mm≤W≤1.55 mm; (15)

0.24 mm²≤AI≤0.91 mm²; (16)

wherein θ is an angle value between the second surface S12 and the third surface S13, W is a height of the third surface S13 and the extension direction of the height is perpendicular to the optical axis 210, AI is an area of the second surface S12, the second surface S12 intersects the direction of the optical axis 210 and inclines to the direction of the optical axis 210.

By using the above-mentioned annular body and satisfying at least any one of the conditions (12) to (16), the lens device 2 (not shown) can effectively reduce ghost image and improve image quality.

When the condition (12): 20 degrees/mm<0/W<250 degrees/mm is satisfied, the annular body less interferes with the mold when the annular body is manufacturing and increase the stability and reliability of the annular body during assembly which helps to improve the production efficiency of the lens device.

When the condition (13): 0.2 mm/mm2<W/AI<9 mm/mm2 is satisfied, the energy of the ghost image can be effectively decreased and effectively eliminated ring-shaped ghost and half-moon ghost.

Tables 4, 5, and 6 show the parameters and condition values for conditions (12)-(13) in accordance with the second embodiment of the invention. It can be seen from Tables 4, 5, and 6 that the annular body 200 of the lens device 2 (not shown) of the second embodiment satisfies the conditions (12)-(16). Tables 4 and 6 show the parameters and condition values for conditions (12)-(13) in accordance with the preferred embodiment of the invention.

TABLE 4
θ = 20 degrees

| W(mm) | AI(mm²) | θ/W(degrees/mm) | W/AI(mm⁻¹) |
|---|---|---|---|
| 0.25 | 0.9081 | 80 | 0.28 |
| 0.35 | 0.8674 | 57.14 | 0.40 |
| 0.45 | 0.8266 | 44.44 | 0.54 |
| 0.55 | 0.7858 | 36.36 | 0.70 |
| 0.65 | 0.745 | 30.77 | 0.87 |
| 0.75 | 0.7042 | 26.67 | 1.07 |
| 0.85 | 0.6633 | 23.53 | 1.28 |
| 0.95 | 0.6223 | 21.05 | 1.53 |

TABLE 5
θ = 45 degrees

| W(mm) | AI(mm²) | θ/W(degrees/mm) | W/AI(mm⁻¹) |
|---|---|---|---|
| 0.2 | 0.4453 | 225 | 0.45 |
| 0.25 | 0.4355 | 180 | 0.57 |
| 0.35 | 0.4157 | 128.57 | 0.84 |
| 0.45 | 0.396 | 100 | 1.14 |
| 0.55 | 0.3763 | 81.82 | 1.46 |
| 0.65 | 0.3566 | 69.23 | 1.82 |
| 0.75 | 0.3368 | 60 | 2.23 |
| 0.85 | 0.317 | 52.94 | 2.68 |
| 0.95 | 0.2972 | 47.37 | 3.20 |
| 1.55 | 0.1784 | 29.03 | 8.69 |

TABLE 6
θ = 60 degrees

| W(mm) | AI(mm²) | θ/W(degrees/mm) | W/AI(mm⁻¹) |
|---|---|---|---|
| 0.25 | 0.3548 | 240 | 0.70 |
| 0.35 | 0.3387 | 171.43 | 1.03 |
| 0.45 | 0.3226 | 133.33 | 1.39 |
| 0.55 | 0.3065 | 109.09 | 1.79 |
| 0.65 | 0.2904 | 92.31 | 2.24 |
| 0.75 | 0.2742 | 80 | 2.74 |
| 0.85 | 0.2581 | 70.59 | 3.29 |
| 0.95 | 0.2419 | 63.16 | 3.93 |

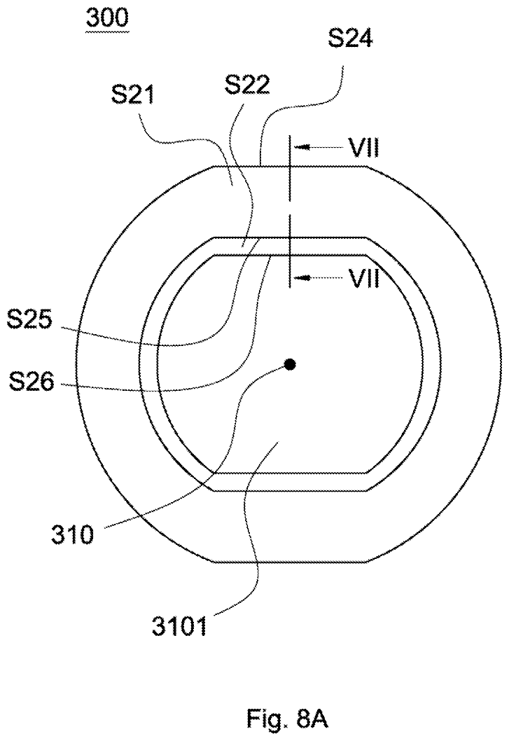

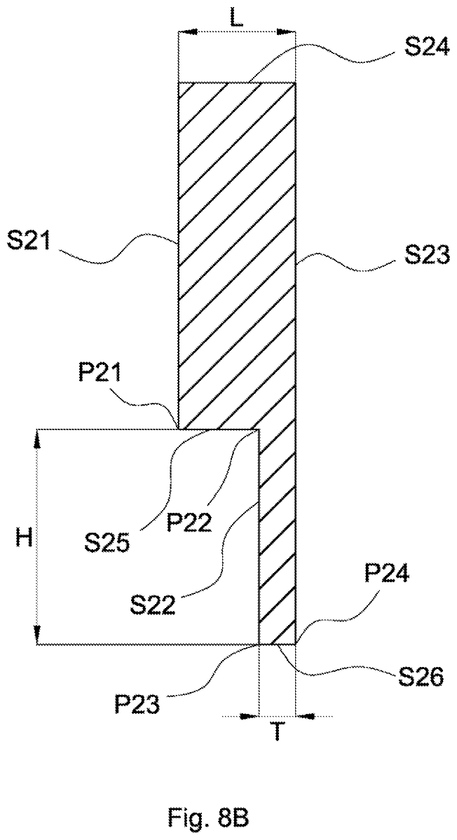

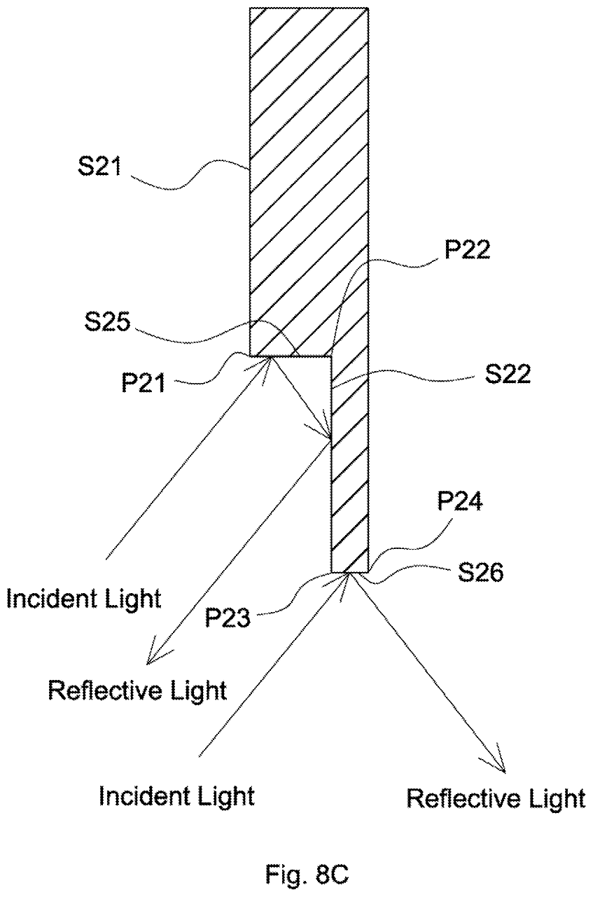

Please refer to FIG. 8A and FIG. 8B at the same time, FIG. 8A is a schematic diagram of a first part surface view of an annular body of a lens device in accordance with a third embodiment of the invention and FIG. 8B is a schematic diagram of a VII-VII sectional view of the annular body in according to FIG. 8A. As shown in FIGS. 8A and 8B, the lens device 3 (not shown) includes a plurality of lenses (not shown) and an annular body 300. The plurality of lenses (not shown) and the annular body 300 are arranged along an optical axis 310. The annular body 300 is disposed between a first side (not shown) and a second side (not shown). The annular body 300 may be disposed between the first side (not shown) and the plurality of lenses (not shown), between the plurality of lenses (not shown), or between the plurality of lenses (not shown) and the second side (not shown). The annular body 300 may be made of metal and includes a first part surface and a second part surface. The first part surface includes a first surface S21, a second surface 822, a fourth surface S24, a fifth surface S25, and a sixth surface 826. The second part surface includes a third surface S23. The first surface S21 and the second surface S22 face the first side. The third surface S23 faces the second side. The first surface S21 connects the fourth surface S24 and the fifth surface S25, respectively. The second surface S22 connects the fifth surface S25 and the sixth surface S26, respectively. The third surface S23 connects the fourth surface S24 and the sixth surface S26, respectively. The fifth surface 825 intersects the second surface S22, preferably they are perpendicular to each other. The shape of the annular body 300 can be non-circular, such as racetrack shape, polygon, polygon symmetrical to optical axis, bottle shape, oak barrel shape or upper half of red wine bottle. The second surface S22 forms a hole 3101 around the optical axis 310. The hole 3101 is non-circular, such as racetrack shape, polygon, polygon symmetrical to optical axis, bottle shape, oak barrel shape, upper half of red wine bottle, a shape formed by cutting out upper or lower portions of a circle, wave shape, zigzag shape, concave-convex shape, petal shape, and heart shape. The hole 3101 allows the light from the first side (not shown) to pass through, and its dimension affects the amount of light passing through the lens device (not shown), so the main function of the annular body 300 is the stop function.

Please refer to FIG. 8C, FIG. 8C is a schematic diagram of optical paths of incident light on the annular body of FIG. 8A. When the incident light from the first side (not shown) enters the annular body 300, most of the incident light is blocked by the first surface S21 and cannot pass through the hole 3101, but part of the incident light is directly reflected to change the light path to the second surface S22 after incident on the fifth surface S25. Because the fifth surface S25 and the second surface S22 are perpendicular to each other, making the reflected light which is directed in the direction of the incident light and can't pass through the hole 3101 to produce ghost or stray light. But very small amount of incident light is reflected by directly changing the light path after incident on the sixth surface S26, although the reflected light will pass through the hole 3101 and finally imaged on the image plane to form a so-called ghost image, but the energy of the ghost image is relatively small at this time and the impact on the image quality is limited. In other words, the ghost image and stray light of the lens device is decreased and the image quality is improved. Problems such as ghost image and stray light have been improved.

In addition, the annular body 300 satisfies at least one of the following conditions:

5<H/T<48; (17)

9 mm<B/H<11 mm; (18)

3<B/CA<50; (19)

0.05 mm≤H≤0.15 mm; (20)

0.1×L≤T≤0.4×L; (21)

0.02 mm≤L<2 mm; (22)

wherein H is a height of the second surface S22, the extension direction of the height is perpendicular to the direction of the optical axis 310, T is a thickness between the second surface S22 and the third surface S23, and the extension direction of the thickness is parallel to the direction of the optical axis 310, B is an area of the second surface S22, the second surface S22 is perpendicular to the direction of optical axis 310, CA is an area of the sixth surface S26, the sixth surface S26 is parallel to the direction of the optical axis 310, L is a thickness of the fourth surface S24, the extension direction of the thickness is parallel to the direction of the optical axis 310.

By using the above-mentioned annular body and satisfying at least any one of the conditions (17) to (22), the lens device 3 (not shown) can effectively reduce ghost image and improve image quality.

When the condition (17): 5<H/T<48 is satisfied, it can effectively reduce the energy of ghost and achieve the elimination of radial ghost, strong light ghost and ring ghost.

When the condition (18): 9 mm<B/H<11 mm is satisfied, it can effectively reduce the production cost. Because the ghost image problem is improved, the number of the disassembly engineering due to ghost image problem can be decreased, so as to decrease production cost and improve the manufacturing yield rate.

When condition (19): 3<B/CA<50 is satisfied, the ghost energy can be effectively reduced and the radial ghost, strong light ghost, and ring ghost can be eliminated to improve the image quality of the lens device.

Tables 7, 8, and 9 show the parameters and condition values for conditions (17)-(19) in accordance with the third embodiment of the invention. It can be seen from Tables 7, 8, and 9 that the annular body 300 of the lens device 3 (not shown) of the third embodiment satisfies the conditions (17)-(22).

TABLE 7
L = 0.02 mm
A = 0.05 mm

| | | | | |
|---|---|---|---|---|
| T(mm) | 0.002 | 0.004 | 0.006 | 0.008 |
| B(mm²) | 0.5139 | 0.5139 | 0.5139 | 0.5139 |
| C(mm²) | 0.0334 | 0.0668 | 0.1002 | 0.1336 |
| A/T | 25 | 12.5 | 8.3333 | 6.25 |
| B/A(mm) | 10.278 | 10.278 | 10.278 | 10.278 |
| B/CA | 15.39 | 7.6948 | 5.1299 | 3.8474 |

TABLE 8
L = 0.033 mm
A = 0.1 mm

| | | | | |
|---|---|---|---|---|
| T(mm) | 0.0033 | 0.0066 | 0.0099 | 0.0132 |
| B(mm²) | 1.0437 | 1.0437 | 1.0437 | 1.0437 |
| C(mm²) | 0.0334 | 0.0668 | 0.1002 | 0.1336 |
| A/T | 30.303 | 15.152 | 10.101 | 7.5758 |
| B/A(mm) | 10.437 | 10.437 | 10.437 | 10.437 |
| B/CA | 31.255 | 15.628 | 10.418 | 7.8138 |

TABLE 9
L = 0.033 mm
A = 0.15 mm

| | | | | |
|---|---|---|---|---|
| T(mm) | 0.0033 | 0.0066 | 0.0099 | 0.0132 |
| B(mm²) | 1.5894 | 1.5894 | 1.5894 | 1.5894 |
| C(mm²) | 0.0334 | 0.0668 | 0.1002 | 0.1336 |
| A/T | 45.455 | 22.727 | 15.152 | 11.364 |
| B/A(mm) | 10.596 | 10.596 | 10.596 | 10.596 |
| B/CA | 47.597 | 23.798 | 15.866 | 11.899 |

It is noted that the thickness L of the fourth surface S24 in Table 8 to Table 9 are equal to 0.033 mm. However, the present invention is not limited thereto. The thickness L of the fourth surface S24 can be greater than or equal to 0.02 mm and less than 2 mm. The holes in the above embodiments are all racetrack (non-circular), i.e. a shape formed by cutting out upper or lower portions of a circle, but it can be understood that if the holes are modified to hexagon (non-circular), octagon (non-circular), polygon, polygon symmetrical to optical axis, bottle shape, oak barrel shape, upper half of red wine bottle, wave shape, zigzag shape, concave-convex shape, petal shape, and heart shape, should also belong to the scope of the present invention.

It can be seen from FIG. 8B that the first surface S21 connects the fifth surface S25 and then the fifth surface S25 connects the second surface S22. The first surface S21 and the second surface S22 are not on the same plane but have a step difference. After the first surface S21, the fifth surface S25 and the second surface S22 are connected, the outer shape is stepped and the stepped shape is formed on the side close to the first side. In other embodiments, the first surface S21 and the second surface S22 can also be on the same plane and the third surface S23 has a step difference, so that the third surface S23 and the fifth surface S25 are connected to each other in a stepped shape. In other words, the stepped shape is formed on the side close to the second side.

The interval between the second surface and the third surface along the optical axis direction is smaller than the interval between the first surface and the third surface along the optical axis direction for the annular body of all embodiments of the present invention. It can be seen from FIG. 7B that the first surface S11 connects the third surface S13 via two turning points P11 and P12. It can be seen from FIG. 8B that the first surface S21 connects the third surface S23 via four turning points P21, P22, P23, and P24.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens device comprising:
at least one lens group which is with refractive power;
a first reflective element, and
a second reflective element;
wherein the lens group enters the lens device from a first side to a second side along an optical path for imaging;
wherein the first reflective element comprises a first reflective surface and is disposed between the first side and the lens group;
wherein the second reflective element comprises a second reflective surface and is disposed between the first reflective surface and the second side;
wherein the lens device satisfies:
22 mm<G1+LB<49 mm;
wherein G1 is a maximum effective optical diameter of all the lenses in the lens group closest to the first side and LB is an interval from the first reflective surface to the second reflective surface along the optical path.

2. The lens device as claimed in claim 1, further comprising an image sensor element and the image sensor element comprising a sensing surface disposed on an image plane and the sensing surface comprising a long side and a short side.

3. The lens device as claimed in claim 1, wherein:
the lens device comprises a plurality of lens groups, each of which comprises at least one lens; and
the lens device zooms from a wide-angle end to a telephoto end by moving all the lens groups along the optical path at the same time, by moving part of the lens groups along the optical path at the same time, or by moving single one of the lens groups along the optical path.

4. The lens device as claimed in claim 1, wherein:
the lens group closest to the first side comprises at least one lens;
the first reflective element further comprises a first incident surface and a first exit surface, the first incident surface and the first exit surface are perpendicular to each other; and
the lens device satisfies:
1<C/G1<2;
wherein C is a thickness of the first reflective element and the thickness is equal to a length of one side of the first exit surface along a direction perpendicular to the first incident surface.

5. The lens device as claimed in claim 1, wherein:
the lens device comprises a plurality of lens groups, between which the lens group closest to the second side comprises at least one lens;
the first reflective element further comprises a first incident surface and a first exit surface, the first incident surface and the first exit surface are perpendicular to each other; and
the lens device satisfies:
1.1<C/G3<2.2;
wherein C is a thickness of the first reflective element, the thickness is equal to a length of one side of the first exit surface along a direction perpendicular to the first incident surface, and G3 is a maximum effective optical diameter of all the lenses in the lens group closest to the second side.

6. The lens device as claimed in claim 2, wherein the lens device comprises a plurality of lens groups, and an incident light sequentially passes through the first reflective element, the lens group closest to the first side, the lens group second closest to the second side, the second reflective element, and the lens group closest to the second side, to form an image on the image sensor element.

7. The lens device as claimed in claim 2, wherein the first reflective element further comprises a first incident surface and a first exit surface, the first incident surface and the first exit surface are perpendicular to each other, and the lens device satisfies:
1.2<C/S<3.5;
wherein C is a thickness of the first reflective element and the thickness is equal to a length of one side of the first exit surface along a direction perpendicular to the first incident surface, and S is a length of the short side of the sensing surface.

8. The lens device as claimed in claim 1, wherein the first reflective element is a prism or a mirror and the second reflective element is a prism or a mirror.

9. The lens device as claimed in claim 1, wherein:
the lens device comprises a plurality of lens groups, each of which comprises at least one lens;
the first reflective element further comprises a first incident surface and a first exit surface, the first incident surface and the first exit surface are perpendicular to each other; and
the lens device satisfies at least one of following conditions:
45 mm<LA<70 mm;
20 mm<LB<42 mm;
4 mm<C≤7.5 mm;
4 mm<G1<7 mm;
2.5 mm<G3<5.5 mm;
where LA is an interval from the first reflective surface to an image plane along the optical path, G3 is a maximum effective optical diameter of all the lenses in the lens group closest to the second side, and C is a thickness of the first reflective element, wherein the thickness is equal to a length of one side of the first exit surface along a direction perpendicular to the first incident surface.

10. The lens device as claimed in claim 1, wherein:
the lens device comprises a plurality of lens groups, each of which comprises at least one lens;
the first reflective element further comprises a first incident surface and a first exit surface, the first incident surface and the first exit surface are perpendicular to each other; and
the lens device satisfies at least one of following conditions:
1<LA/LB<5;
25 mm<C+LB<50 mm;
where LA is an interval from the first reflective surface to an image plane along the optical path and C is a thickness of the first reflective element, wherein the thickness is equal to a length of one side of the first exit surface along a direction perpendicular to the first incident surface.

11. A lens device comprising:
at least one lens group which is with refractive power; and
an annular body;
wherein the lens group enters the lens device from a first side to a second side along an optical axis for imaging;
wherein the annular body is disposed between the first side and the second side;
wherein the lens group and the annular body are arranged along the optical axis;
wherein the annular body comprises a first part surface and a second part surface, wherein the first part surface comprises a first surface and a second surface, the second part surface comprises a third surface, the first surface faces the first side, the third surface faces the second side, and the second surface is between the first surface and the third surface;
wherein the second surface surrounds the optical axis to form a hole;
wherein the lens device satisfies:
0.24 mm²≤AI≤0.91 mm²;
wherein AI is an area of the second surface.

12. The lens device as claimed in claim 11, wherein the annular body is disposed between the first side and the lens group, between the lens group, or between the lens group and the second side, and the lens device satisfies at least one of following conditions:
20 degrees/mm<θ/W<250 degrees/mm;
0.2 mm/mm²<W/AI<9 mm/mm²;
wherein the second surface inclines to the optical axis and forms an angle with the third surface, θ is an angle value of the angle between the second surface and the third surface, W is a height of the third surface and the extension direction of the height is perpendicular to the optical axis, and AI is the area of the second surface.

13. The lens deice as claimed in claim 11, further comprising a first reflective element and a second reflective element, wherein:
the first reflective element comprises a first reflective surface and is disposed between the first side and the lens group;
the second reflective element comprises a second reflective surface and is disposed between the first reflective surface and the second side; and
the lens group, the first reflective element, the second reflective element, and the annular body are arranged along the optical axis.

14. The lens device as claimed in claim 13, further comprising an image sensor element and the image sensor element comprising a sensing surface disposed on an image plane and the sensing surface comprising a long side and a short side, wherein:
the first reflective element further comprises a first incident surface and a first exit surface, the first incident surface and the first exit surface are perpendicular to each other; and
the lens device satisfies at least one of following conditions:
20 degrees≤θ≤60 degrees;
0.2 mm≤W≤1.55 mm;
22 mm<G1+LB<49 mm;
1<C/G1<2;
1.1<C/G3<2.2;
1.2<C/S<3.5;
45 mm<LA<70 mm;
20 mm<LB<42 mm;
4 mm<C5 7.5 mm;
4 mm<G1<7 mm;
2.5 mm<G3<5.5 mm;
1<LA/LB<5;
25 mm<C+LB<50 mm;
20 degrees/mm<θ/W<250 degrees/mm;
0.2 mm/mm²<W/AI<9 mm/mm²;
wherein the second surface inclines to the optical axis and forms an angle with the third surface, θ is an angle value of the angle between the second surface and the third surface, W is a height of the third surface and the extension direction of the height is perpendicular to the optical axis, G1 is a maximum effective optical diameter of all the lenses in the lens group closest to the first side, LB is an interval from the first reflective surface to the second reflective surface along the optical path, C is a thickness of the first reflective element and the thickness is equal to a length of one side of the first exit surface along a direction perpendicular to the first incident surface, G3 is a maximum effective optical diameter of all the lenses in the lens group closest to the second side, S is a length of the short side of the sensing surface, LA is an interval from the first reflective surface to an image plane along the optical path, and AI is the area of the second surface.

15. A lens device comprising:
at least one lens group which is with refractive power, and
an annular body;
wherein the lens group enters the lens device from a first side to a second side along an optical axis for imaging;
wherein the annular body is disposed between the first side and the second side;
wherein the lens group and the annular body are arranged along the optical axis;
wherein the annular body comprises a first part surface and a second part surface, wherein the first part surface comprises a first surface and a second surface, the second part surface comprises a third surface, the first surface faces the first side, the third surface faces the second side, and the second surface is between the first surface and the third surface;
wherein the second surface surrounds the optical axis to form a hole;
wherein the lens device satisfies:
5<H/T<48;
wherein H is a height of the second surface, the extension direction of the height is perpendicular to the optical axis, T is a thickness between the second surface and the third surface, and the extension direction of the thickness is parallel to the optical axis.

16. The lens device as claimed in claim 15, wherein the annular body is disposed between the first side and the lens group, between the lens group, or between the lens group and the second side, the second surface faces the first side, the first part surface further comprises a fourth surface, a fifth surface, and a sixth surface, the fourth surface connects the first surface and the third surface, the second surface connects the fifth surface and the sixth surface, the fifth surface intersects the second surface, the sixth surface connects the second surface and the third surface, and the lens device satisfies at least one of the following conditions:
9 mm<B/H<11 mm;
3<B/CA<50;
0.1×L≤T≤0.4×L;
wherein B is an area of the second surface, H is the height of the second surface, the extension direction of the height is perpendicular to the optical axis, CA is an area of the sixth surface, L is a thickness of the fourth surface, the extension direction of the thickness is parallel to the optical axis, and T is the thickness between the second surface and the third surface and the extension direction of the thickness is parallel to the optical axis.

17. The lens device as claimed in claim 16, wherein the lens device satisfies following condition:
0.05 mm≤H≤0.15 mm;
wherein H is the height of the second surface.

18. The lens device as claimed in claim 16, wherein the lens device satisfies following condition:
0.02 mm≤L≤2 mm;
wherein L is the thickness of the fourth surface.

19. The lens device as claimed in claim 15, further comprising a first reflective element and a second reflective element, wherein:
the first reflective element comprises a first reflective surface and is disposed between the first side and the lens group;
the second reflective element comprises a second reflective surface and is disposed between the first reflective surface and the second side; and
the lens group, the first reflective element, the second reflective element, and the annular body arranged along the optical axis.

20. The lens device as claimed in claim 19, further comprising an image sensor element and the image sensor element comprising a sensing surface disposed on an image plane and the sensing surface comprising a long side and a short side, wherein:
the first reflective element further comprises a first incident surface and a first exit surface, the first incident surface and the first exit surface are perpendicular to each other,
the hole is a non-circular hole and an interval between the second surface and the third surface along the optical axis is smaller than an interval between the first surface and the third surface along the optical axis;
the annular body is a non-circular annular body and made of metal or polyethylene terephthalate (PET);
the first surface and the third surface are connected by at least two turning points; and
the lens device satisfies at least one of following conditions:
0.2 mm≤W≤1.55 mm;
9 mm<B/H<1 mm;
3<B/CA<50;
0.1×L≤T≤0.4×L;
0.05 mm≤H≤0.15 mm;
0.02 mm≤L≤2 mm;
22 mm<G1+LB<49 mm;
1<C/G1<2;
1.1<C/G3<2.2;
1.2<C/S<3.5;
45 mm<LA<70 mm;
20 mm<LB<42 mm;
4 mm<C≤7.5 mm;
4 mm<G1<7 mm;
2.5 mm<G3<5.5 mm;
1<LA/LB<5;
25 mm<C+LB<50 mm;
wherein W is a height of the third surface and the extension direction of the height is perpendicular to the optical axis, B is an area of the second surface, H is the height of the second surface and the extension direction of the height is perpendicular to the optical axis, CA is an area of the sixth surface, L is a thickness of the fourth surface and the extension direction of the thickness is parallel to the optical axis, T is the thickness between the second surface and the third surface and the extension direction of the thickness is parallel to the optical axis, G1 is a maximum effective optical diameter of all the lenses in the lens group closest to the first side, LB is an interval from the first reflective surface to the second reflective surface along the optical path, C is a thickness of the first reflective element and the thickness is equal to a length of one side of the first exit surface along a direction perpendicular to the first incident surface, G3 is a maximum effective optical diameter of all the lenses in the lens group closest to the second side, S is a length of the short side of the sensing surface, and LA is an interval from the first reflective surface to an image plane along the optical path.
